(19) United States
(12) Patent Application Publication
(10) Pub. No.: US 2022/0259230 A1
(43) Pub. Date: Aug. 18, 2022

(54) NOVEL ALKYNYL AMINOBORANES, PROCESS FOR PREPARING SAME AND USES THEREOF

(71) Applicants: UNIVERSITE DE BORDEAUX, BORDEAUX (FR); INSTITUT POLYTECHNIQUE DE BORDEAUX, TALENCE CEDEX (FR); CENTRE NATIONAL DE LA RECHERCHE SCIENTIFIQUE, PARIS CEDEX 16 (FR)

(72) Inventors: Mathieu PUCHEAULT, CAMBLANES ET MEYNAC (FR); Mélodie BIREPINTE, VILLENAVE D'ORNON (FR)

(21) Appl. No.: 17/765,553

(22) PCT Filed: Oct. 2, 2020
(86) PCT No.: PCT/EP2020/077709

§ 371 Date: Mar. 31, 2022

(30) Foreign Application Priority Data
Oct. 4, 2019 (FR) FR1911000

(51) Int. Cl. C07F 5/02

(52) U.S. Cl. CPC C07F 5/027

(57) ABSTRACT

Disclosed are novel alkynyl aminoboranes, wherein the method for preparing same includes bringing into contact in a single synthesis step a terminal alkyne, an aminoborane and an organomagnesium, in particular a Grignard reagent.

### BACKGROUND OF THE INVENTION

### Field of the Invention

The present invention relates to new alkynylaminoboranes, their method of preparation and their uses.

### Description of the Related Art

Alkynylaminoboranes are compounds exhibiting both the particularities of alkynylboranes and aminoboranes.

Alkynylboranes and their derivatives are synthetic intermediates used in many synthetic strategies.

These organoboron derivatives allow, for example, the introduction of aryl, alkenyl or alkynyl groups on synthesis intermediates thanks to reactions catalyzed by transition metals.

They are used in coupling, cyclization, cycloisomerization or polymerization reactions, which can be regioselective.

These compounds can be prepared by deprotonation of the terminal alkyne with a strong base (organomagnesium and organolithium) in stoichiometric quantity and the addition of a borylation agent, such as chloroaminoborane (J. Org. Chem. 1995, 489, 51-62) or such as an alkyl borate (US 2011-0201806). However, the use of a stoichiometric amount of a base leads to the formation of salts, which leads to a loss of yield and to obtaining a product of low purity.

Alkynylboranes can be obtained by dehydrogenating coupling using transition metals (Advanced Synthesis & Catalysis, 2018, 360, 19, 3649-3654; J. Org. Chem. 829, 11-13) or pinacol-borane (Chemical Science, 2015, 6(11), 6572-6582). However, these reagents are expensive and they require working under drastic conditions (control of the addition of reagents, temperature control).

Furthermore, these methods for preparing alkynylboranes are not entirely satisfactory.

A known method for obtaining aminoboranes is that described in patent EP 1 458 729.

The method described in this patent comprises the reaction between diisopropylaminoborane (DIPOB) of formula (iPr)₂NBH₂ and a compound of formula A-X, in which A can be an alkynyl group and X is a halogenated leaving group, in the presence of a palladium catalyst. The method described in this document is carried out in two distinct steps and requires on the one hand a transformation reaction to obtain the DI POB by heating, and on the other hand the use of an expensive metallic catalyst to prepare the aminoborane, which limits its use on an industrial scale. In this document, the alkynyl function carried by group A is not reactive during the method described.

### SUMMARY OF THE INVENTION

Thus, there is a need to have a method for the preparation of alkynylaminoboranes, making it possible to overcome the drastic conditions (control of the rate of addition, cryogenic temperature) required by the methodes of the prior art, not requiring the use of an expensive transition metal and/or an unstable and/or expensive borylating agent and allowing the selective preparation of an alkynylaminoborane or one of its derivatives with high yields and excellent purity.

A first aspect of the present invention is a method for the preparation of alkynylaminoboranes with a method requiring a single synthetic step.

A second aspect of the present invention is the production of new alkynylaminoborane compounds.

A third aspect of the present invention is the use of aminoboranes for the preparation of alkynylaminoboranes in a single synthetic step.

A fourth aspect of the present invention is the use of an organomagnesium for the preparation of alkynylaminoboranes.

A fifth aspect of the present invention is the use of alkynylaminoboranes as reaction intermediates for coupling or multistep syntheses.

The inventors have shown that it is possible to prepare alkynylaminoboranes in a single synthetic step by bringing a terminal alkyne, a borylating agent and an organomagnesium into contact.

The subject of the present invention is a method for the preparation of an alkynylaminoborane of the following formula (I):

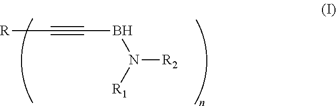

wherein R is:
a linear or branched alkyl group of 1 to 18 carbon atoms, optionally bearing at least one substituent,
a linear or branched alkenyl or alkynyl group of 2 to 18 carbon atoms, optionally bearing at least one substituent,
a cycloalkyl or cycloalkenyl group of 3 to 18 carbon atoms, optionally bearing at least one substituent,
a heterocycloalkyl or heterocycloalkenyl group, optionally bearing at least one substituent,
an aryl group of 2 to 12 carbon atoms, where the aryl is chosen from the group of aromatics or heteroaromatics, optionally bearing at least one substituent,
an alkyl aryl group, where the aryl is chosen from the group of aromatics or heteroaromatics, optionally bearing at least one substituent,
a halogen chosen from F, Cl, Br and I,
a silyl group, —SiRₐR_{b}R_{c}, —RₐSiR_{b}R_{c}R_{d}, —RₐOSiR_{b}R_{c}R_{d},
a group —ORₐ, —NHRₐ, —NRₐR_{b}, —SRₐ, —CF₃, —NO₂, —RₐOR_{b}, —RₐNHR_{b}, —RₐNR_{b}R_{c}, —RₐSR_{b}, wherein Rₐ, R_{b}, R_{c} and R_{d}, identical or different, represent H, Cl atoms, linear or branched alkyl, alkenyl, alkynyl, cycloalkyl, cycloalkenyl, aryl groups, in particular phenyl, or aromatic or non-aromatic heterocyclic groups, of 1 to 18 carbon atoms, optionally bearing at least one substituent, where said substituents are chosen from:
a linear, branched or cyclic alkyl groups of 1 to 18 carbon atoms,
the halogens F, Cl, Br and I,
OH,

n is an integer from 1 to 3,

R₁ and R₂ are identical or different groups, chosen from:
a linear, branched or cyclic alkyl groups of 1 to 18 carbon atoms, optionally substituted by one or more identical or different OR₃ groups, in which R₃ is an alkyl group of 1 to 18 carbon atoms, linear, branched or cyclic,
arylalkyl groups, optionally substituted by one or more identical or different OR₃ groups, in which R₃ is a linear, branched or cyclic alkyl group of 1 to 18 carbon atoms,
the two groups R and R₂ possibly being linked together to form a cycle, comprising bringing them into contact in a single synthesis step:
a terminal alkyne, of the following formula:

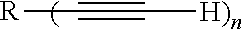

R having the meanings indicated previously,
an aminoborane of formula BH₂—NR₁R₂

R₁ and R₂ having the meanings indicated above and

R₁ and R₂ are chosen to allow steric hindrance with respect to the amine function equivalent to that of diisopropylaminoborane (DIPOB) of formula BH₂—N(iPr)₂,
and an organomagnesium, in particular a Grignard reagent of formula R′—MgX,

wherein:
X is a halogen selected from the group consisting of F, Cl, Br and I
R′ is selected from the group comprising:
a linear or branched alkyl of 1 to 18 carbon atoms,
a linear or branched alkenyl of 2 to 18 carbon atoms,
a linear or branched alkynyl of 2 to 18 carbon atoms,
a cycloalkyl of 3 to 18 carbon atoms,
a cycloalkenyl of 3 to 18 carbon atoms,
an aryl with 2 to 12 carbon atoms, where the aryl is chosen from the group of aromatics or heteroaromatics,
an alkyl aryl, where the aryl is chosen from the group of aromatics or heteroaromatics.

The method according to the invention uses an organomagnesium as a catalyst.

An organomagnesium is not a complex of a transition metal.

In formula (I), it is understood that when n varies from 1 to 3, the group R has a valence n of alkynylaminoborane functions and the structural possibilities of the group of R are adapted accordingly.

For example when R is a Cl alkyl group, R is a —CH₃ group if n is equal to 1, R is a —CH₂— group if n is equal to 2 and R is a CH— group if n is equal to 3.

When R is a C2 alkenyl group, R is a CH₂═CH group if n is equal to 1, R is a —CH═CH— group if n is equal to 2 and R is a C═CH— group if n is equal at 3.

When R is a C2 alkynyl group, R is a CH≡C— group if n is equal to 1, R is a —C≡C— group if is equal to 2 and the valence n cannot be equal to 3, because the R group cannot not carry three alkynylaminoborane functions.

For the amine groups in the variants of R, the alkynylaminoborane function can
be linked directly to the N atom, for example in the case of —NHRₐ and —NRₐR_{b} groups,
or be linked via the Rₐ groups, for example in the case of the —RₐNHR_{b} and —RₐNR_{b}R_{c} groups; where we understand that Rₐ can not be H or Cl

It is the same for the groups of R with Si, O or S.

In one embodiment of the method of the invention, the group R is a silyl group —SiRₐR_{b}R_{c} wherein Rₐ, R_{b} and R_{c}, identical or different, represent H, Cl, alkyl groups with 1 to 18 carbon atoms or phenyls.

By “steric hindrance with respect to the amine function equivalent to that of diispropylaminoborane”, is meant within the meaning of the invention a steric hindrance similar to that provided by two isopropyl substituents preventing by their arrangement and their volume the approach of a reagent on the amine function.

This steric hindrance, a priori, should be quantifiable by appropriate techniques (Tolman angle, N-B distance).

The desired steric hindrance has the effect of allowing the aminoborane, in solution, to be present at a rate of at least 10% in monomer form.

The method according to the present invention is carried out in a single synthesis step, i.e. a so-called one-pot procedure, using low-cost raw materials (alkyne, metals such as magnesium, aminoboranes or amine-borane complexes) which allow the implementation of the reaction on an industrial scale.

Advantageously, in another embodiment of the method of the invention, the aminoborane is chosen from the group comprising diisopropylaminoborane (DIPOB), dicyclohexylaminoborane, tetramethylpiperidine aminoborane (tmp-BH₂), ter-butylmethylaminoborane (tBuMeN-BH₂).

In one embodiment of the method of the invention, the aminoborane has identical R₁ and R₂ groups

In another embodiment of the method of the invention, n is equal to 1, 2 or 3, preferably n is equal to 1.

In one embodiment, the invention relates to a method for preparing an alkynylaminoborane of formula (I),

wherein R₁ and R₂ are isopropyl groups, said alkynylaminoborane corresponding to the following formula (II):

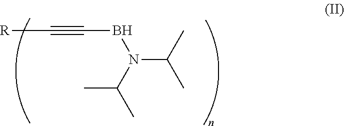

wherein R and n have the meanings indicated above, and said aminoborane is diisopropylaminoborane (DIPOB) of formula BH₂—N(iPr)₂,

In one embodiment, the organomagnesium is selected from PhMgBr, VinylMgBr, EtMgBr, MeMgBr, iPrMgBr, iPrMgCl, and is preferably PhMgBr.

The aminoborane used in the method of the invention can be obtained commercially or by synthesis.

It can also be generated from an amine-borane complex during the borylation reaction of the alkyne in the single step of the method according to the invention.

Within the meaning of the present invention, the term “amine-borane complex” of formula H₃B←NHR₁R₂ means a compound comprising a BH₃ group whose vacant p orbital is filled by the pair of electrons of an amine NHR₁R₂.

Mention may be made, as an example of an amine-borane complex, of diisopropylamine-borane (DIPAB) of formula H₃B←NH(iPr)₂.

In one mode of the method according to the invention, the aminoborane of formula BH₃←NHR₁R₂ is formed in situ during the single synthesis step, by dehydrogenation reaction of an amine-borane complex of formula H₃B←NHR₁R₂ and of a organomagnesium.

The organomagnesium catalyzes the dehydrogenation reaction of the amine-borane complex, forming aminoborane, according to the following reaction scheme:

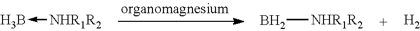

Within the meaning of the present invention, the term “formed in situ” means the fact that the aminoborane is formed directly during the implementation of the method by mixing the amine-borane complex and an organomagnesium in the single synthesis step.

This organomagnesium can be chosen identical to that R′—MgX used in the parallel borylation reaction of the terminal alkyne.

The method of the invention can thus be carried out in a single simultaneous step of formation of the aminoborane and borylation of the alkyne.

The reaction balance can be schematized as follows:

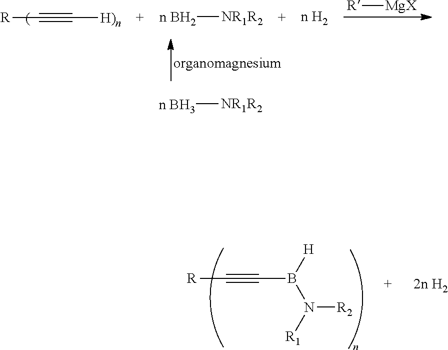

R′—MgX allows the borylation reaction of the alkyne. The organomagnesium allows the continuous in situ supply of aminoborane by dehydrogenation of the amine-borane complex.

Amine-borane complexes are known for their stability towards water, air and light.

It is thus possible to select amine-borane complexes, some of which are more chemically stable and/or commercially available than their aminoborane homologs.

In an advantageous embodiment of the method of the invention, the organomagnesium used for the in-situ generation of the aminoborane from the amine-borane complex is a Grignard reagent of formula R′MgX wherein X and R′ have the meanings indicated above, preferably PhMgBr or CH₃MgBr.

Advantageously, the organomagnesiums for the borylation reaction of the alkyne and the in-situ generation of the aminoborane are identical and consist of a Grignard reagent.

Thus, a single organomagnesium is introduced into the method of the invention.

This organomagnesium allows both the dehydrogenation of the amine-borane complex into aminoborane and the borylation reaction of the terminal alkyne.

The introduction of the same organomagnesium makes it possible to limit the nature and the quantity of catalyst used and thus to avoid parasitic cross-reactions.

According to one embodiment of the method according to the invention, the aminoborane is diisopropylaminoborane (DIPOB) of formula BH₂—N(iPr)₂, formed in situ during the single synthesis step.

In this case, the DIPOB is formed by the dehydrogenation reaction of the diisopropylamine-borane (DIPAB) complex of formula H₃B←NH(iPr)₂ with an organomagnesium, preferably PhMgBr or CH₃MgBr.

Advantageously, the organomagnesium is a Grignard reagent of formula R′—MgX wherein X and R′ have the meanings indicated above.

R′—MgX is preferably PhMgBr or CH₃MgBr.

According to one embodiment, the method is carried out in the absence of a catalyst of the transition metal type.

The method according to the invention advantageously makes it possible to avoid the use of a catalyst of the transition metal type which may be toxic and/or expensive.

In the present invention, organomagnesium is a compound capable of reacting with alkyne and borane in the absence of a transition metal such as palladium, nickel, rhodium or ruthenium.

According to one embodiment, the method is carried out in the absence of a base.

The method according to the invention advantageously makes it possible to avoid the use in the medium of an additional base which can promote the formation of uncontrolled secondary products.

In the present invention, the organomagnesium is a catalyst which is capable on its own of reacting the alkyne and the borane.

The method according to the invention does not require the addition of a base such as triethylamine (Et₃N) unlike reactions using a transition metal as catalyst.

According to an advantageous embodiment, the method is carried out in the absence of solvent.

The method according to the invention has the advantage of making it possible to use crude liquid reagents having the role of solvent.

It makes it possible to avoid the use of solvents, which has advantages in economic and ecological terms.

According to another advantageous embodiment, the method is carried out in the presence of a solvent, in particular an aprotic solvent.

The method according to the invention allows the use of a wide range of solvents.

Indeed, it can be implemented with solvents usually used in industry.

The solvent can thus be chosen for reasons of cost, toxicity or adaptation to any other synthesis steps.

Advantageously, the solvent is chosen from the group comprising methylterbutylether (MTBE), tetrahydrofuran (THF), N,N-Dimethylformamide (DMF), benzene, deuterated benzene (C₆D₆), toluene, xylene, diethylether (Et₂O) or a mixture of said solvents, preferably MTBE.

According to an advantageous embodiment, the invention relates to a method wherein the organomagnesium is used in an amount ranging from 5 mol % to 15 mol %.

The use of organomagnesium in a substoichiometric quantity, advantageously in a catalytic quantity, makes it possible to avoid the formation of salts or residual products.

It thus makes it possible to promote the yield and the purity of the product.

According to an advantageous embodiment, the method is carried out at ambient temperature, that is to say at temperatures of between 10° C. and 40° C., in particular of the order of 20° C. to 30° C. Working at room temperature eliminates the constraint of temperature control of the reaction.

In particular, it is not necessary to heat the reaction mixture or to maintain the reaction at a cryogenic temperature to implement the method according to the invention.

According to an advantageous embodiment, the method is carried out in less than one hour, preferably in less than 5 to 10 minutes.

The method according to the invention has the effect of not requiring the maintenance of reaction conditions for more than one hour, promoting the industrialization of the method.

Advantageously, the invention relates to a method wherein the conversion rate of alkyne to alkynylaminoborane is greater than 80%, preferably greater than 97%.

In particular, the yield of the method according to the invention is quantitative.

The term “conversion rate” means the rate of terminal alkyne having reacted during the method.

This rate can be determined by analyzing the final product obtained by ¹H NMR.

The comparison of the signal of the propargylic proton, on which the deprotonation reaction takes place, with that of the other protons of the alkyne serving as a reference, makes it possible to evaluate the quantity of alkyne having reacted during the method according to the invention.

The alkynylaminoborane obtained according to the method of the invention does not require an additional purification step because the purity of the product obtained is greater than 90%, in particular greater than 91%, 92%, 93%, 94%, 95%, 96%, 97%, 98% or 99%.

Within the meaning of the present invention “purification step” means any step subsequent to the synthesis step making it possible to increase the purity of the alkynylaminoborane.

Examples of purification steps include liquid chromatography, high performance liquid chromatography, recrystallization or distillation.

The purification steps do not include the step of filtration of the mixture, on kielselghur or on diatomaceous earth, and evaporation of the solvent.

Advantageously, in one embodiment, the subject of the method is the preparation of an alkynylaminoborane of formula (I) corresponding to one of the following formulas:

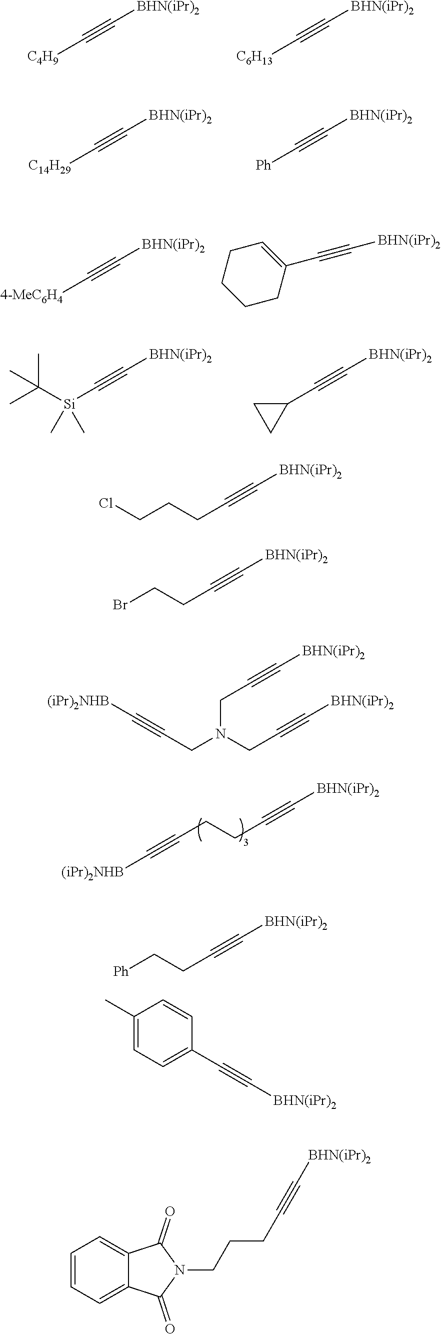

The method according to the invention is characterized by a release of dihydrogen quantifiable by known methods such as gas chromatography.

When aminoborane is used as a reagent according to the method of the invention, the reaction balance of the method according to the invention is as follows:

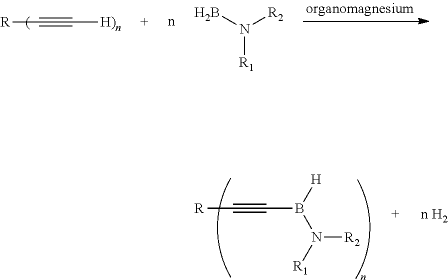

The molar amount of dihydrogen generated during the single synthesis step is n times greater than the molar amount of alkynylaminoborane.

By way of example, the method of the invention with DIPOB and R′MgX has the following reaction balance:

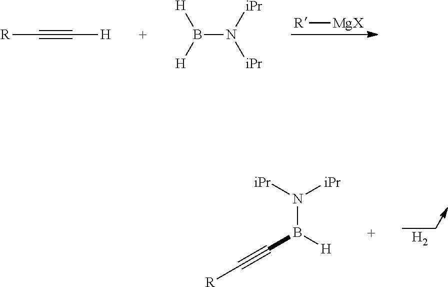

A molar quantity of dihydrogen released was found to be identical to the molar quantity of alkynylaminoborane produced during the method.

When the amine-borane complex is used as a reagent for the insitu formation of aminoborane according to the method of the invention, the reaction balance can be schematized as follows:

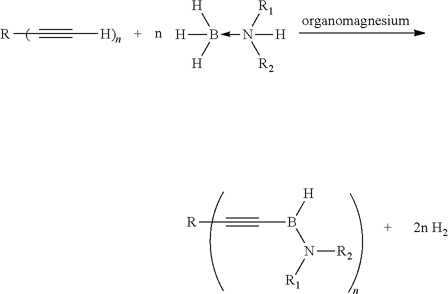

The gas evolution of dihydrogen is twice as great as the above method using aminoborane as the starting reagent.

The molar quantity of dihydrogen and alkynylaminoborane indicate the presence of dehydrogenation of the amine-borane complex in parallel with a borylation reaction of the alkyne according to the method.

By way of example, the reaction according to the method of the invention with DIPAB as the amine-borane complex and R′MgX, has the following reaction balance:

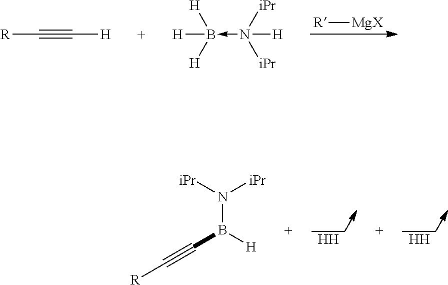

Dehydrogenation of DIPAB and deprotonation of the alkyne occur in tandem in the single step of the method of the invention.

A molar amount twice as large of dihydrogen compared to the molar amount of alkynylaminoborane, is obtained when the method is implemented.

The molar ratio between the dihydrogen generated during a single-step method and the quantity of alkynylaminoborane produced by this method is an indicator of the implementation of a method according to the invention.

The inventors have observed the presence, in the form of traces, in the product of the method, of the acynylaminoborane hydride of formula (A) below:

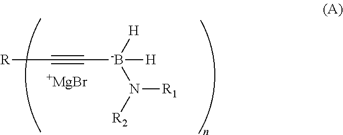

This hydride of formula (A) can be isolated and detected in the product of the method of the invention, for example by ¹¹B NMR. Advantageously, this hydride is characteristic of a method according to the invention and may serve as a signature of the method of the invention.

Without being bound by theory, a reaction mechanism is proposed according to the scheme below in a method of the invention implementing the diisopropylamine-borane complex (DIPAB), source of aminoborane, and PhMgBr as organomagnesium:

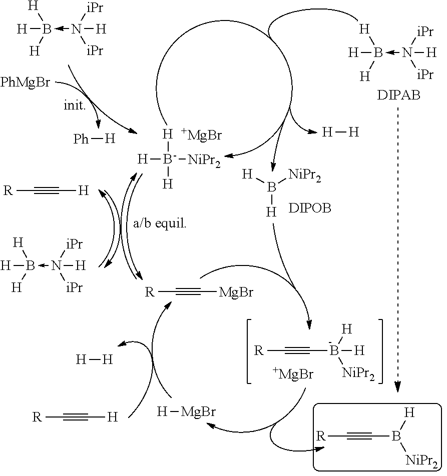

The dehydrogenation reaction of DIPAB to DIPOB and the borylation reaction of the alkyne are implemented in the single tandem synthesis step.

The transformation of DIPAB into DIPOB takes place via a hydride —BH₃—N(iPr)₂ obtained by reacting another molecule of DIPAB with PhMgBr.

The borylation reaction proceeds by deprotonation of the propargylic proton of the alkyne by H—MgBr to form an intermediate R—C≡C—MgBr. This intermediate reacts with the borylating agent, DIPOB, to form the corresponding acynylaminoborane hydride of formula (A).

The latter releases a proton to form the final product.

According to a mechanism hypothesis, the method involves the following chemical balances in the method of the invention:

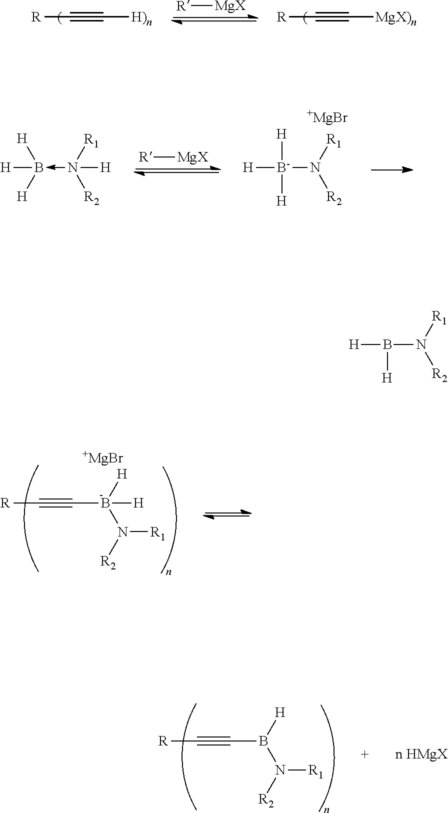

Thus, the presence of these equilibria in a single synthesis step and the identification of the compounds involved in these equilibria would make it possible to confirm the use of a method according to the invention.

The invention relates to alkynylaminoboranes, belonging to the family of alkynylboranes, which has an alkynyl function directly linked to the boron atom which bears an amine function.

The invention also relates to a compound of formula (I) below:

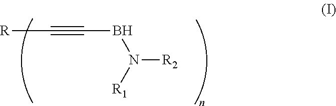

wherein R is:
a linear or branched alkyl group of 1 to 18 carbon atoms, optionally carrying at least one substituent,
a linear or branched alkenyl or alkynyl group of 2 to 18 carbon atoms, optionally bearing at least one substituent,
a cycloalkyl or cycloalkenyl group of 3 to 18 carbon atoms, optionally bearing at least one substituent,
a heterocycloalkyl or heterocycloalkenyl group, optionally bearing at least one substituent,
an aryl group of 2 to 12 carbon atoms, where the aryl is chosen from the group of aromatics or heteroaromatics, optionally carrying at least one substituent,
an alkyl aryl group, where the aryl is chosen from the group of aromatics or heteroaromatics, optionally bearing at least one substituent,
a halogen chosen from F, Cl, Br, and I,
a silyl group —SiRₐR_{b}R_{c}, —RₐSiR_{b}R_{c}R_{d}, —RₐOSiR_{b}R_{c}R_{d},
an —ORₐ, —NHRₐ, —NRₐR_{b}, —SRₐ, —CF₃, —NO₂, —RₐOR_{b}, —RₐNHR_{b}, —RₐNR_{b}R_{c}, —RₐSR_{b} group wherein Rₐ, R_{b}, R_{c} and R_{d}, identical or different, represent H, Cl, linear or branched alkyl, alkenyl, alkynyl, cycloalkyl, cycloalkenyl, aryl groups, in particular phenyl, or heterocyclic aromatic or non-aromatic groups, of 1 to 18 carbon atoms, optionally bearing at least one substituent, where said substituents are chosen from:
a linear, branched or cyclic alkyl groups of 1 to 18 carbon atoms,
the halogens F, Cl, Br and I—OH n is an integer from 1 to 3,

R₁ and R₂ are identical or different groups, chosen from:
a linear, branched or cyclic alkyl groups with 1 to 18 carbon atoms, optionally substituted by one or more identical or different OR₃ groups, wherein R₃ is a linear, branched or cyclic alkyl group with 1 to 18 carbon atoms,
arylalkyl groups, optionally substituted by one or more identical or different OR₃ groups, wherein R₃ is a linear, branched or cyclic alkyl group of 1 to 18 carbon atoms, the two groups R₁ and R₂ possibly being connected to form together a cycle,

wherein R₁ and R₂ are chosen to allow steric hindrance with respect to the amine function equivalent to that of diisopropylaminoborane (DIPOB) of formula BH₂—N(iPr)₂,

In one embodiment, the invention relates to a compound of formula (I), in which n is equal to 1 and has the following formula (I-1):

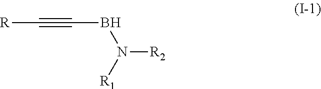

wherein R, R₁ and R₂ have the meanings indicated above.

In one embodiment, the invention relates to a compound of formula (I), in which n is equal to 1,

R is a silyl group —SiRₐR_{b}R_{c}, in particular Rₐ, R_{b} and R_{c}, identical or different, are chosen from H, Cl atoms, alkyl groups with 1 to 18 carbon atoms or phenyl groups,

R₁ and R₂ are identical, and have the following formula (I-1-1):

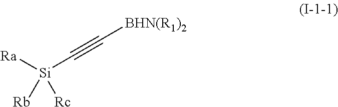

wherein R₁ has the meanings indicated above.

In one embodiment, the invention relates to a compound of formula (I) wherein n is equal to 2 and has the following formula (I-2):

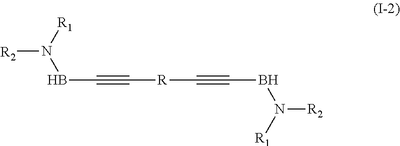

wherein R, R₁ and R₂ have the meanings indicated above.

In one embodiment, the invention relates to a compound of formula (I), wherein n is equal to 3 and has the following formula (I-3):

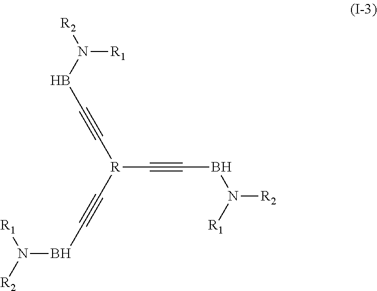

wherein R, R₁ and R₂ have the meanings indicated above.

In one embodiment, the invention relates to a compound wherein R₁ and R₂ are isopropyl groups and has the following formula (II):

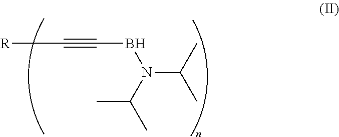

wherein R and n have the meanings indicated above.

In one embodiment, the invention relates to a compound of formula (II), wherein n is equal to 1 and has the following formula (II-1):

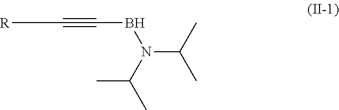

wherein R has the meanings indicated above.

In one embodiment, the invention relates to a compound of formula (II), wherein n is equal to 2 and has the following formula (II-2):

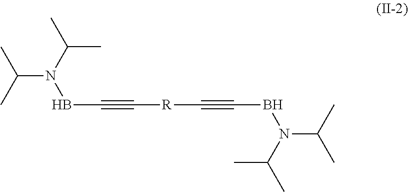

wherein R has the meanings indicated above.

In one embodiment, the invention relates to a compound of formula (II), wherein n is equal to 3 and has the following formula (II-3):

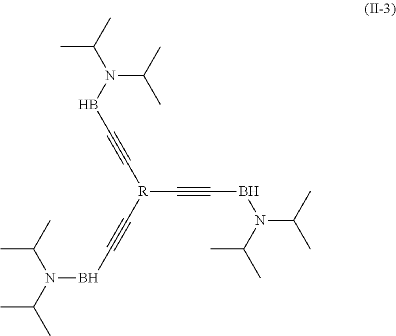

wherein R has the meanings indicated above.

In one embodiment, the invention relates to a compound of formula (I) corresponding to one of the following formulas:

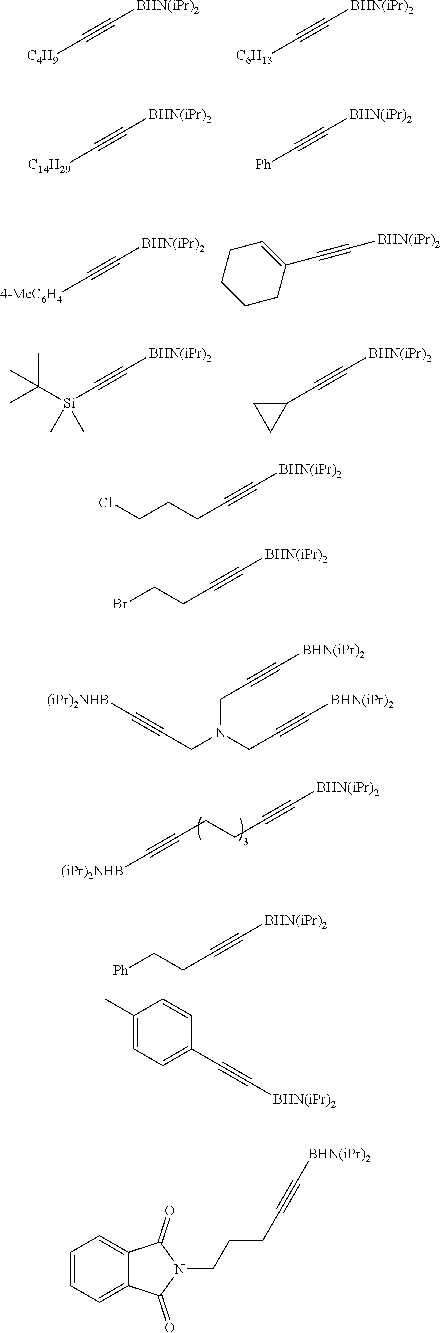

Another object of the invention relates to the use of an aminoborane of formula BH₂—NR₁R₂ for the implementation of a method for the preparation of an alkynylaminoborane according to the invention.

In one embodiment, the invention relates to the use of an aminoborane of formula BH₂—NR₁R₂ for the implementation of a method for the preparation of an alkynylaminoborane derivative of the following formula (I):

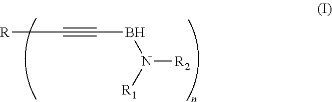

wherein n, R, R₁ and R₂ have the meanings indicated above,

from a compound of the following formula:

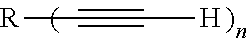

in the presence of an organomagnesium, optionally a solvent, in a single synthesis step.

In one embodiment, the invention relates to the use of DIPOB for the implementation of a method for the preparation of a compound of formula (II):

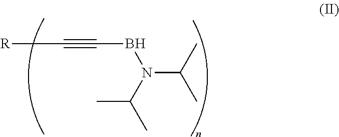

wherein n and R have the meanings indicated above, at starting from a compound of the following formula:

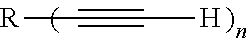

in the presence of an organomagnesium compound, optionally of a solvent, in a single synthesis step.

In another embodiment, the invention relates to the use of an amine-borane complex of formula BH₃←NHR₁R₂ for the implementation of a method for the preparation of an alkynylaminoborane according to the invention.

In another embodiment, the invention relates to the use of diisopropylamineborane (DIPAB) of formula H₃B←NH(iPr)₂ for the implementation of a method for the preparation of an alkynylaminoborane according to the invention.

Another object of the invention is the use of an organomagnesium, preferably a Grignard reagent of formula R′—MgX where R′ and X have the meanings indicated above, for the implementation of a method for preparing an alkynylaminoborane according to the invention.

In another embodiment, the invention relates to the use of an organomagnesium in a substoichiometric quantity, preferably from 5 to 15 mol %, for the implementation of a method for the preparation of an alkynylaminoborane according to the invention.

Another object of the present invention relates to the use of the compounds of formula (I) according to the invention as intermediate reaction compounds.

Another object of the present invention is the use of the compounds of formula (I) according to the invention for multistep or coupling syntheses, preferably for the Suzuki, Chan-Lam-Evans and Petasis reactions.

The alkynylaminoborane compounds of the invention are intermediate compounds allowing the introduction of aryl, alkenyl or alkynyl groups on synthesis intermediates thanks to reactions catalyzed by transition metals (Pd, Cu, Rh, Ni) such as Suzuki, of Chan-Lam-Evans and Petasis reactions.

They can be used as reagents in coupling, cyclization, cycloisomerization or polymerization reactions, which can be regioselective.

The present invention is illustrated by means of the non-limiting examples described below.

### DESCRIPTION OF THE PREFERRED EMBODIMENTS

Examples relating to the preparation of alkynylaminoboranes:

### Example 1

### General Protocol for the Preparation of Alkynylaminoboranes:

To a solution of the terminal alkyne (10 mmol, 1 eq) and aminoborane or the amine-borane complex (10 mmol, 1 eq) in 20 mL of solvent, the organomagnesium is added in a catalytic quantity (0.5 mmol, 5 mol %) initiating the alkyne borylation reaction.

The reaction takes place at room temperature (RT) for 10 minutes.

A release of dihydrogen H₂ is observed during the reaction.

The final product is obtained after filtration on Celite of the solution and evaporation of the solvent.

Product yield is evaluated.

The products are analyzed by ¹H and ¹¹B NMR.

r.t. and Ta are used to indicate: ambient temperature.

Conversion Rate:

The conversion is relative to the disappearance of the alkyne.

The conversion rate is determined using the ¹H NMR signals by comparison between the signals of the protons of the alkyne not involved during the reaction which serve as a reference and the signal of the propargyl proton.

Thus, a total conversion of 100% corresponds to the total disappearance of the quantity of starting alkyne introduced, indicating that all the alkynes have been transformed during the method.

### Example 2: Variation of Organomagnesiums (Nature and Quantity)

Alkynylaminoborane 2a is obtained from alkyne 1a and diisopropylaminoborane (DIPOB) of formula BH₂—N(iPr)₂ in methylterbutylether (MTBE) in the presence of an organomagnesium (R′—MgX) according to the general protocol described in Example 1, following the following reaction scheme:

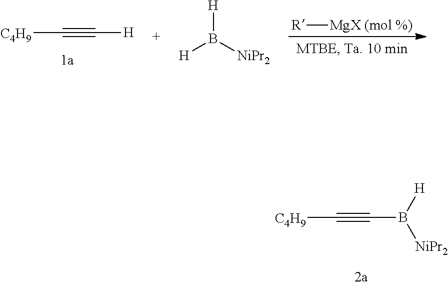

Tests were carried out in order to determine the influence of the nature of the organomagnesium and the quantity of organomagnesium introduced (in mol % relative to the alkyne) on the rate of conversion of alkyne is to alkynylaminoborane 2a.

The degree of conversion is evaluated by ¹H and ¹¹B NMR on the final product obtained.

The results have been reported in Table 1.

A conversion rate of 100% is obtained for the Grignard reagents in an amount of 5 mol %. When the organomagnesium content decreases from 5% to 1%, the conversion rate decreases to 87%, and therefore remains above 80%.

TABLE 1
Variation of organomagnesiums

| | | Quantity of | Con- |
|---|---|---|---|
| | | organomagnesium | version^{[a]} |
| Assays | RMgX | (mol %) | (%) |
| 1 | PhMgBr | 5 | 100 |
| 2 | VinylMgBr | 5 | 100 |
| 3 | EtMgBr | 5 | 100 |
| 4 | iPrMgCl | 5 | 100 |
| 5 | MeMgBr | 5 | 100 |
| 6 | MeMgBr | 4 | 91 |
| 7 | MeMgBr | 3 | 89 |
| 8 | MeMgBr | 2 | 89 |
| 9 | MeMgBr | 1 | 87 |

^{[a]}Evaluated by ¹H and ¹¹B NMR.

### Example 3: Variation of the Solvent

Alkynylaminoborane 2a is obtained from alkyne 1a and DIPAB in the presence of PhMgBr at 5 mol % in different solvents according to the protocol described in example 1 according to the following reaction scheme:

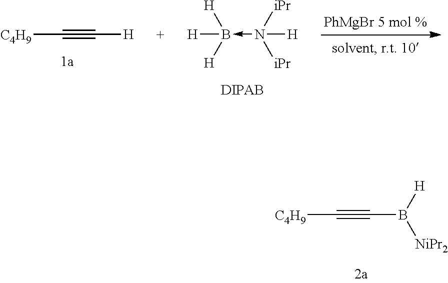

Tests were carried out to determine the influence of the nature of the solvent on the rate of conversion of alkyne is to alkynylaminoborane 2a.

A test 9 with the crude reagents was carried out without solvent.

The degree of conversion is evaluated by ¹H and ¹¹B NMR on the final product obtained.

The results have been reported in Table 2.

The reaction in toluene shows a conversion rate of 73%.

A conversion rate of 100% is obtained with the other solvents tested MTBE, THF, C₆D₆, Et₂O as well as with the crude reagents.

It should be noted that the test with the crude reagents allows, without solvent, a total conversion of the terminal alkyne into alkynylaminoborane.

TABLE 2
Solvent variation

| | | Quantity of | Con- |
|---|---|---|---|
| | | organomagnesium | version^{[a]} |
| Test | Solvent | (mol %) | (%) |
| 1 | MTBE | 5 | 100 |
| 2 | THF | 5 | 100 |
| 3 | C₆D₆ | 5 | 100 |
| 4 | Toluene | 5 | 73 |
| 5 | Et₂O | 5 | 100 |
| 9 | Neat | 5 | 100 |

^{[a]}Evaluated by ¹H and ¹¹B NMR.

### Example 4: Alkynylaminoborane Compounds

Different alkynylaminoboranes 2 are obtained from terminal alkyne 1 and diisopropylamine borane (DIPAB) in the presence of PhMgBr at 5 mol % in MTBE according to the protocol described in example 1 according to the following scheme:

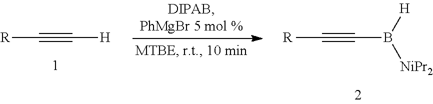

Tests were carried out with several R groups including alkyl groups (2a, 2b, 2c, 2l), cyclic groups (2f, 2h), aryl or alkylaryl groups (2d, 2e, 2m), alkylaromatic groups (2n, 2o), silyl groups (2g), amine groups (2k), groups substituted by halides (2i, 2j).

Compound 2l is an illustrative example of a compound of formula (I) where n=2.

Compound 2k is an illustrative example of a compound of formula (I) where n=3.

The conversion rate is evaluated by ¹H et ¹¹B NMR. The results of the conversion rate and the yield after purification of the final products are reported in Table 3.

A conversion rate of 100% is obtained for all the compounds, allowing a quantitative yield of the final products obtained, ranging from 83% to 98%.

TABLE 3
Alkynylaminoborane compounds

| compound | Structure | Conversion (%) | yield (%) |
|---|---|---|---|
| 2a | 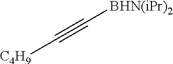 | 100 | 85 |
| 2b | 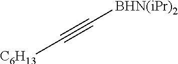 | 100 | 85 |
| 2c | 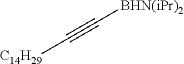 | 100 | 98 |
| 2d | 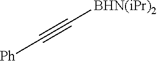 | 100 | 93 |
| 2e | 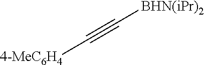 | 100^{a} | 91 |
| 2f | 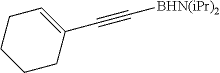 | 100 | 93 |
| 2g | 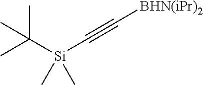 | 100 | 94 |
| 2h | 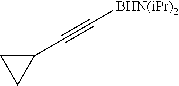 | 100 | — |
| 2i | 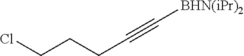 | 100 | 93 |
| 2j | 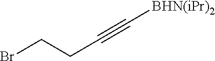 | 100 | 87 |
| 2k | 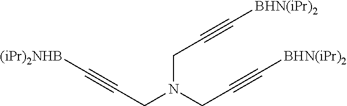 | 100^{c} | 92 |
| 2l | 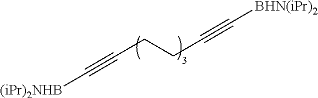 | 100^{d} | 92 |
| 2m | 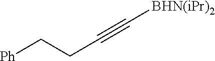 | 100 | 83 |
| 2n | 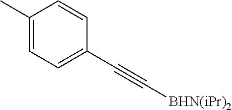 | 100 | 91 |
| 2o | 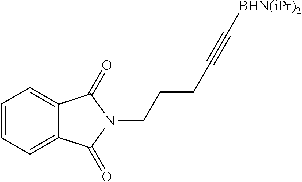 | 100 | 91 |

Compounds 2a and 2n were prepared with MeMgBr instead of PhMgBr.
Compound 2h has a lower boiling point than MTBE.
Compound 2k is prepared with 3 equivalents of DIPAB, compound 2l with 2 equivalents of DIPAB. Compound 2o is prepared in THF instead of MTBE.

1. Method for the preparation of alkynylaminoborane of the following formula (I): 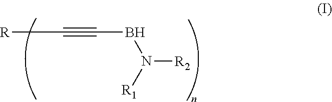
wherein R is:
a linear or branched alkyl group of 1 to 18 carbon atoms, optionally bearing at least one substituent,
a linear or branched alkenyl or alkynyl group of 2 to 18 carbon atoms, optionally bearing at least one substituent,
a cycloalkyl or cycloalkenyl group of 3 to 18 carbon atoms, optionally bearing at least one substituent,
a heterocycloalkyl or heterocycloalkenyl group, optionally bearing at least one substituent,
an aryl group of 2 to 12 carbon atoms, where the aryl is chosen from the group of aromatics or heteroaromatics, optionally bearing at least one substituent,
an alkyl aryl group, where the aryl is chosen from the group of aromatics or heteroaromatics, optionally bearing at least one substituent,
a halogen chosen from F, Cl, Br and I,
a silyl group —SiRₐR_{b}R_{c}, —RₐSiR_{b}R_{c}R_{d}, —RₐOSiR_{b}R_{c}R_{d},
an —ORₐ, —NHRₐ, —NRₐR_{b}, —SRₐ, —CF₃, —NO₂, —RₐOR_{b}, —RₐNHR_{b}, —RₐNR_{b}R_{c}, —RₐSR_{b} group wherein Rₐ, R_{b}, R_{c}, and R_{d}, identical or different, represent H, Cl, linear or branched alkyl, alkenyl, alkynyl, cycloalkyl, cycloalkenyl, aryl groups, optionally bearing at least one substituent, where said substituents are chosen from:
a linear, branched or cyclic alkyl groups of 1 to 18 carbon atoms,
the halogens F, Cl, Br and I,
OH
n is an integer from 1 to 3,
R₁ and R₂ are identical or different groups, chosen from:
a linear, branched or cyclic alkyl groups of 1 to 18 carbon atoms, optionally substituted by one or more identical or different OR₃ groups, wherein R₃ is a linear, branched or cyclic alkyl group of 1 to 18 carbon atoms,
arylalkyl groups, optionally substituted by one or more identical or different OR₃ groups, wherein R₃ is a linear, branched or cyclic alkyl group of 1 to 18 carbon atoms,
the two groups R₁ and R₂ possibly being linked together to form a cycle, comprising bringing them into contact in a single synthesis step:
a terminal alkyne, with the following formula: 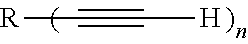
R having the meanings indicated previously,
an aminoborane of formula BH₂—NR₁R₂,
R₁ and R₂ having the meanings indicated above and
R₁ and R₂ are chosen to allow steric hindrance with respect to the amine function equivalent to that of diisopropylaminoborane (DIPOB) of formula BH₂—N(iPr)₂,
and an organomagnesium, selected in the group consisting of a Grignard reagent of formula R′—MgX, wherein:
X is a halogen selected from the group consisting of F, Cl, Br and I
R′ is selected from the group comprising:
a linear or branched alkyl of 1 to 18 carbon atoms,
a linear or branched alkenyl of 2 to 18 carbon atoms,
a linear or branched alkynyl of 2 to 18 carbon atoms,
a cycloalkyl of 3 to 18 carbon atoms,
a cycloalkenyl of 3 to 18 carbon atoms,
an aryl with 2 to 12 carbon atoms, where the aryl is chosen from the group of aromatics or heteroaromatics,
an alkyl aryl, where the aryl is chosen from the group of aromatics or heteroaromatics.

2. Method for the preparation according to claim 1 of alkynylaminoborane of formula (I), wherein R₁ and R₂ are isopropyl groups, the said alkynylaminoborane corresponding to the following formula (II): 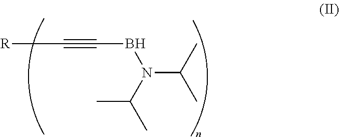
wherein R and n have the meanings indicated in claim 1, and said aminoborane is diisopropylaminoborane (DIPOB) of formula BH₂—N(iPr)₂.

3. Method according to claim 1, wherein the organomagnesium is selected from the group consisting of PhMgBr, VinylMgBr, EtMgBr, MeMgBr, iPrMgBr, iPrMgCl.

4. Method according to claim 1, wherein the aminoborane of formula BH₂—NR₁R₂ is formed in situ during the single synthesis step, by dehydrogenation reaction of an amine-borane complex of formula H₃B←NHR₁R₂ and an organomagnesium.

5. Method according to claim 1, wherein the aminoborane is diisopropylaminoborane (DIPOB) of formula BH₂—N(iPr)₂, formed in situ during the single synthesis step, by dehydrogenation reaction of diisopropylamine-borane (DIPAB) of formula H₃B←NH(iPr)₂ by an organomagnesium.

6. Method according to claim 1, wherein the said method is carried out in the absence of a catalyst of the transition metal type.

7. Method according to claim 1, wherein the said method is carried out in the absence of solvent.

8. Method according to claim 1, wherein the said method is carried out in the presence of a solvent, selected from the group consisting of methylterbutylether (MTBE), tetrahydrofuran (THF), N,N-Dimethylformamide (DMF), benzene, deuterated benzene (C₆D₆), toluene, xylene, diethyl ether (Et₂O) or a mixture of said solvents.

9. Method according to claim 1, wherein the organomagnesium is used in an amount ranging from 5 mol % to 15 mol %.

10. Compound of the following formula (I): 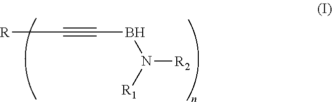
wherein R is:
a linear or branched alkyl group of 1 to 18 carbon atoms, optionally bearing at least one substituent,
a linear or branched alkenyl or alkynyl group of 2 to 18 carbon atoms, optionally bearing at least one substituent,
a cycloalkyl or cycloalkenyl group of 3 to 18 carbon atoms, optionally bearing at least one substituent,
a heterocycloalkyl or heterocycloalkenyl group, optionally bearing at least one substituent,
an aryl group of 2 to 12 carbon atoms, where the aryl is chosen from the group of aromatics or heteroaromatics, optionally bearing at least one substituent,
an alkyl aryl group, where the aryl is chosen from the group of aromatics or heteroaromatics, optionally bearing at least one substituent,
a halogen chosen from F, Cl, Br, and I,
a silyl group —SiRₐR_{b}R_{c}, —RₐSiR_{b}R_{c}R_{d}, —RₐOSiR_{b}R_{c}R_{d},
an —ORₐ, —NHRₐ, —NRₐR_{b}, —SRₐ, —CF₃, —NO₂, —RₐOR_{b}, —RₐNHR_{b}, —RₐNR_{b}R_{c}, —RₐSR_{b} group wherein Rₐ, R_{b}, R_{c} et R_{d}, identical or different, represent H, Cl, a linear or branched alkyl, alkenyl, alkynyl, cycloalkyl, cycloalkenyl, aryl group, optionally bearing at least one substituent, where said substituents are chosen from:
a linear, branched or cyclic alkyl groups of 1 to 18 carbon atoms,
the halogens F, Cl, Br and I,
OH
n is an integer from 1 to 3,
R₁ and R₂ are identical or different groups, chosen from:
a linear, branched or cyclic alkyl groups of 1 to 18 carbon atoms, optionally substituted by one or more identical or different OR₃ groups, wherein R₃ is a linear, branched or cyclic alkyl group of 1 to 18 carbon atoms,
arylalkyl groups, optionally substituted by one or more groups
identical or different OR₃, wherein R₃ is a linear, branched or cyclic alkyl group of 1 to 18 carbon atoms, the two groups R₁ and R₂ possibly being connected to together form a cycle, wherein R₁ and R₂ are chosen to allow a steric hindrance with respect to the amine function equivalent to that of diisopropylaminoborane (DIPOB) of formula BH₂—N(iPr)₂.

11. Compound according to claim 10, wherein R₁ and R₂ are isopropyl groups and has the following formula (II): 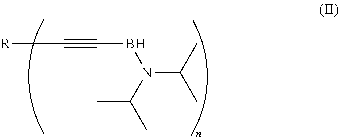
wherein R and n have the meanings indicated in claim 10.

12. Compound of formula (I) according to claim 10 corresponding to one of the following formulas:

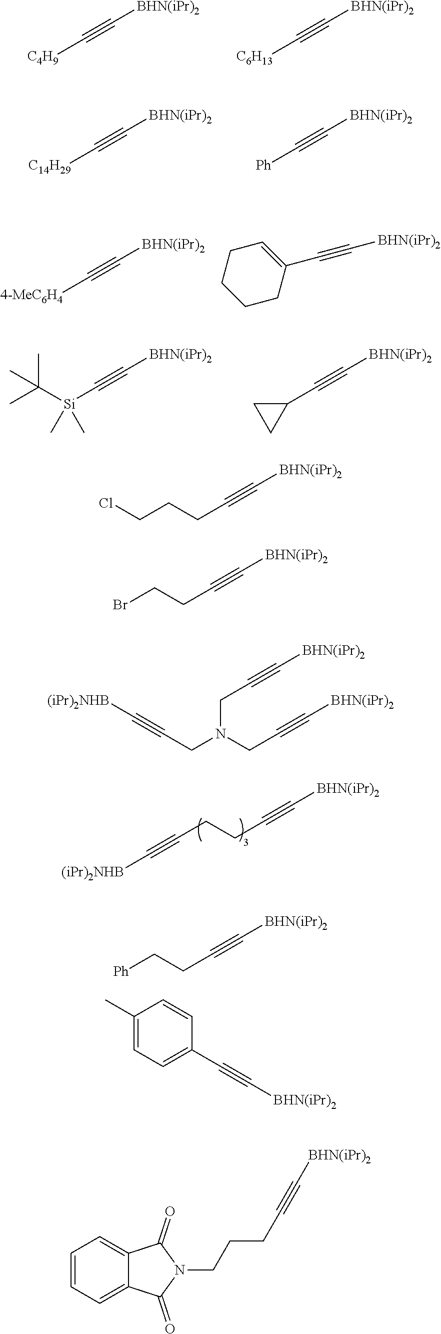

13. (canceled)

14. Method for the preparation of the compounds of formula (I) according to claim 1 wherein said compounds as intermediate reaction compounds, are used for the implementation of multistep or coupling syntheses, selected in the group consisting of the Suzuki, Chan-Lam-Evans and Petasis reactions.

15. The method of claim 3, wherein the organomagnesium is PhMgBr.

16. The method of claim 5, wherein the organomagnesium is PhMgBr.

17. Method according to claim 2, wherein the organomagnesium is selected from the group consisting of PhMgBr, VinylMgBr, EtMgBr, MeMgBr, iPrMgBr, iPrMgCl.

18. Method according to claim 2, wherein the aminoborane of formula BH₂—NR₁R₂ is formed in situ during the single synthesis step, by dehydrogenation reaction of an amine-borane complex of formula H₃B←NHR₁R₂ and an organomagnesium.

19. Method according to claim 3, wherein the aminoborane of formula BH₂—NR₁R₂ is formed in situ during the single synthesis step, by dehydrogenation reaction of an amine-borane complex of formula H₃B←NHR₁R₂ and an organomagnesium.

20. Method according to claim 2, wherein the aminoborane is diisopropylaminoborane (DIPOB) of formula BH₂—N(iPr)₂, formed in situ during the single synthesis step, by dehydrogenation reaction of diisopropylamine-borane (DIPAB) of formula H₃B←NH(iPr)₂ by an organomagnesium.

21. Method according to claim 3, wherein the aminoborane is diisopropylaminoborane (DIPOB) of formula BH₂—N(iPr)₂, formed in situ during the single synthesis step, by dehydrogenation reaction of diisopropylamine-borane (DIPAB) of formula H₃B←NH(iPr)₂ by an organomagnesium.
